(19) United States
(12) Patent Application Publication
(10) Pub. No.: US 2026/0192261 A1
(43) Pub. Date: Jul. 9, 2026

(54) NOZZLE CONFIGURATION AND CARBONATION DEVICE FOR ENHANCING A BEVERAGE

(71) Applicant: A Common Thread, Inc., Brooklyn, NY (US)

(72) Inventors: Grant Kenji Larsen, Austin, TX (US); Charles Weikert, Brooklyn, NY (US); Mohini Boparai, Amsterdam (NL); Sunjay Guleria, Amsterdam (NL); Marcel Ipince, Brooklyn, NY (US); Thijs Faber, Amsterdam (NL); Darryl Robinson, Brooklyn, NY (US); Tucker Jones, New York, NY (US)

(73) Assignee: A Common Thread, Inc., Brooklyn, NY (US)

(21) Appl. No.: 19/559,483

(22) Filed: Mar. 6, 2026

Related U.S. Application Data
(63) Continuation-in-part of application No. PCT/US2025/020275, filed on Mar. 17, 2025.
Application No. PCT/US2025/020275 is a continuation-in-part of application No. 29/965,981, filed on Sep. 30, 2024.
(60) Provisional application No. 63/566,435, filed on Mar. 18, 2024.

(51) Int. Cl. B01F 23/2361; A23L 2/54; B01F 23/236; B01F 23/237; B01F 35/21; B01F 101/14

(52) U.S. Cl. CPC B01F 23/23611; A23L 2/54; B01F 23/2364; B01F 23/237621; B01F 35/2112; B01F 2101/14

(57) ABSTRACT

A carbonation device includes a container cap for mounting to an opening of a liquid container, a cartridge retainer in the container cap for locating a carbonating fluid cartridge relative to the liquid container, and a conduit extending from the cartridge retainer to an interior of the liquid container. The conduit includes a first conduit section defining a segment of the conduit and being a channel having a cross-section with a first area and a second conduit section extending from the first conduit section to the interior of the liquid container. The second conduit section is a channel having a cross-section with a second area smaller than the first area. A carbonating fluid released from a carbonating fluid cartridge retained in the cartridge retainer first passes through the first conduit section and then passes through the second conduit section prior to entering the interior of the liquid container.

### CROSS-REFERENCE TO RELATED APPLICATIONS

This application is a continuation in part from International Patent Application No. PCT/US2025/020275, filed Mar. 17, 2025, which claims the benefit of U.S. Provisional Patent Application No. 63/566,435, filed Mar. 18, 2024, the entire contents of which are hereby incorporated by reference.

International Patent Application No. PCT/US2025/020275 further claims priority from U.S. Design patent application Ser. No. 29/965,981, filed Sep. 30, 2024, the entire contents of which are hereby incorporated by reference.

### FIELD OF THE INVENTION

The invention relates to enhancing a beverage. In particular, the invention relates to enhancing a beverage by carbonating the beverage in a drinking container.

### BACKGROUND

Various fluids may be used to carbonate beverages or otherwise create sparkling beverages, including carbon dioxide.

Typically, carbonation systems are provided either as countertop systems with fillable bottles or as portable systems that include both carbonation mechanisms and a container for retaining a liquid to be carbonated.

Carbon dioxide may be available in pressurized cartridges. However, such cartridges do not typically include control mechanisms, and even cartridges designed for food grade use cannot be used to simply deposit carbon dioxide into a beverage. Further, the integration of a control mechanism, such as safety valves or a flow regulator, into a pressurized cartridge would be prohibitively expensive.

The demand for compact and efficient handheld carbonators has grown significantly, driven by consumers seeking convenient ways to carbonate water and beverages at home or on the go. Traditional carbonation methods typically rely on large, cumbersome equipment or complex systems, creating a barrier for mass adoption.

Commonly, carbonators use canisters filled with liquid carbon dioxide (CO2) to provide the necessary volume of CO2 for the carbonation process. However, this approach introduces a challenge related to the phase change of CO2. When liquid CO2 transitions into a gas, it rapidly cools, potentially causing several issues during the carbonation process.

One common problem is the risk of freezing water when the cold CO2 gas comes into contact with it. Additionally, in some instances, the rapid phase change can lead to the formation of dry ice rather than the desired gaseous CO2. Both of these issues can result in ineffective carbonation and hinder the overall user experience.

These issues are enhanced when integrated into portable or handheld carbonation devices for personal use. Portable devices typically cannot integrate the complicated valving and regulator technology utilized in countertop devices. Further, portable devices are more feasible with smaller CO2 cartridges under an assumption that such cartridges are intended for one time use. However, this means that integration of controls into the CO2 cartridges would lead to prohibitive costs for a disposable component.

Further, existing portable carbonation products require control of an entire carbonation environment, and therefore have very little flexibility regarding a liquid container in which a container to be carbonated is located. Accordingly, typical products include a sealable container in which the entire product is designed for carbonation. However, users may wish to use their existing liquid containers, such as a standard water bottle, and have the ability to carbonate water directly inside such a container.

The use of a container not designed for use with the carbonation device, or not designed for carbonation at all, presents additional challenges.

There is a need for a carbonation device that is portable and compact and usable in various settings and environments.

There is a further need for such a carbonation device that is usable with and compatible with a variety of liquid containers, even if such liquid containers were not manufactured to ideal tolerances.

There is a further need for such a carbonation device designed to prevent freezing resulting in ice formation and/or dry ice formation during a carbonation process.

There is a further need for such a device that ensures a smooth and efficient carbonation process, enhancing user satisfaction.

There is a further need for a device compatible with small CO2 canisters or cartridges, such as 8, 11, 12, or 16 gram CO2 cartridges without the need for a valve mechanism integrated into the canister or cartridge. There is a further need for CO2 canisters designed for efficient manufacture and for use in the context of such a carbonation device.

There is a further need for such a device that fits onto popular water bottles, providing a convenient and versatile carbonation solution.

There is a further need for enhanced valves that can enhance user safety during the carbonation process.

There is a further need for redundancies that can ensure reliable carbonation control and results.

### SUMMARY

To address challenges related to ice formation, this disclosure focuses on optimizing the phase change of CO2 within a compact, handheld carbonator. By implementing a series of innovative features and design modifications, a carbonation device may efficiently control the transition of liquid CO2 to gas. This not only prevents freezing or dry ice formation but also allows for the use of small CO2 canisters without the need for valves on the canisters, making handheld carbonator convenient, practical, cost effective, and reliable for a wide range of applications.

It is understood that references to handheld carbonators may refer to a variety of form factors for carbonation devices. In a typical implementation, the handheld carbonator may take the form of a bottle cap that can be applied to a liquid container or bottle in order to carbonate a liquid already present in or inserted into that container. In some embodiments, the carbonation device does not require use of a designated container included in the system. Instead, the carbonation device may be incorporated into a bottle cap system compatible with a variety of containers, such as all bottles within a designated class of bottles.

In some embodiments, such a bottle cap-based carbonation device may incorporate technology to increase safety across a wide range of container sizes. For example, even within a standardized mouth size for a category of water bottle, the mouth of the bottle may vary in size or may vary in threading geometry. Such a size variance may be within acceptable tolerances for a container for, e.g., still water, but may be unsafe for use with carbonated water or in the context of a carbonation. Accordingly, in some embodiments, technology may be provided for increasing the adaptability of a closure system in order to enhance safety. This may include features that allow threading for the carbonation device to adapt to container threading during use, as well as features designed to carefully control maximum pressures within the device and container.

In some embodiments, the carbonation device may include features allowing it to adapt to different standard mouth sizes.

Our handheld carbonator is designed to carbonate water by injecting CO₂ into it at high pressures. Unlike traditional carbonators that rely on larger CO2 canisters, the device described herein uses smaller canisters, sometimes referred to as “chargers,” to ensure portability and compactness. To achieve effective and controlled CO2 phase change, several features are incorporated into the carbonation devices described herein. While the various features may contribute independently to providing an improved user experience, improved results, and improved safety margins, the benefits of the features enhance each other, and therefore provide substantially improved results when utilized in concert.

### Small Volume Components:

Components of the devices described herein for use in the carbonation device are designed to have minimal volume, controlling the expansion of CO2 during the phase change. This controlled expansion may ensure that the CO2 remains in its gaseous form and does not form dry ice, facilitating smooth and efficient carbonation.

### Thermal Isolation:

Recognizing the importance of thermal control during the carbonation process, the devices described herein may incorporate measures to thermally isolate the gas flow path from the water. This isolation prevents cooling effects at the injector orifice, eliminating the risk of ice plugs forming inside the injector nozzle and blocking the CO2 flow.

### Gas Flow Path Geometry:

The carbonation device described herein provides an internal gas flow path, in some embodiments, features two strategically placed orifices. The first, which may be a 0.4 mm diameter orifice at the puncture of the CO2 canister, limits the amount of liquid CO2 that exits the canister. The second, which may be a 0.6 mm diameter orifice at the injector, creates a fine mist of CO2 bubbles, optimizing carbonation and preventing ice or dry ice formation.

### Pressure Relief Valve Enhancements:

A modified pressure relief valve may be provided to increase its opening pressure and flow rate, ensuring a smooth injection process and preventing ice or dry ice from forming.

Embodiments of our handheld carbonator combine these innovative features to deliver an exceptional user experience, efficiently carbonating water and beverages with small CO2 canisters in an upside-down configuration, all without the need for valves on the CO2 canister.

Further, in some embodiments, the handheld carbonator described offers safe and precise carbonation while fitting onto a variety of water bottles, as noted above. This can include popular stainless steel water bottles such as Hydro Flask® brand water bottles. These bottles come in various sizes, catering to different preferences and lifestyles.

As noted above, the compatibility of the carbonation device described with existing water bottles poses unique challenges. The design and specifications of such existing water bottles may be diverse, and the bottles can vary in size and shape. Ensuring safe and effective carbonation across a range of bottle designs is a key focus of the carbonation device described.

In response to these challenges, the carbonation device described incorporates enhanced pressure relief valves, precise pressure management, user education, and ongoing safety evaluations to ensure a secure and reliable carbonation experience, irrespective of the specific water bottle used.

Accordingly, the handheld carbonator serves as a lid for standard water bottles, pressurizing the water inside to create sparkling water. Embodiments of the device feature enhanced pressure relief valves designed specifically for enhancing the safety of such a product, ensuring the safety of users during the carbonation process.

### Low-Pressure, Low-Flow Rate Relief Valve:

In some embodiments, a low-pressure, low-flow rate pressure relief valve may be incorporated and designed to open at lower pressures. This valve, while allowing minimal gas flow, ensures that the pressure within the water bottle is safely reduced to below, e.g., 20 psi, significantly reducing the risk of accidents. By maintaining a low flow rate, it would not impact the initial pressure build-up during CO₂ injection, providing a seamless carbonation process. It is noted that the specific pressure at which the low-pressure safety valve maintains the bottle may be varied, but would remain lower than carbonation pressures.

### High-Pressure, High-Flow Rate Relief Valve:

In addition, the carbonation device described may be equipped with a high-pressure, high-flow rate pressure relief valve, designed to rapidly release gas and lower the pressure inside the water bottle when it reaches higher levels. This feature enhances safety by preventing excessive pressure buildup.

### Carbonation Relief Valves (Redundancy):

To ensure adequate pressure is maintained during the carbonation process, in some embodiments, two or more carbonation relief valves may be provided. These valves work in tandem, controlling the pressure buildup in the water bottle as required by Henry's law, which governs the carbonation process. The redundancy of at least two valves may enhance reliability and safety.

### Precise Carbonation Control:

In some embodiments, the carbonation device implements more precise carbonation control. By utilizing CO2 canisters that consistently inject the same amount of CO2, the system can be designed to reach a desired pressure without the need for a carbonation pressure relief valve. This approach, guided by the ideal gas law, ensures that carbonation is achieved with accuracy, eliminating the risk associated with pressure relief valves during carbonation.

In some embodiments, the device further comprises a pressure release button for lowering pressure & therefore decreasing required torque to remove the handheld carbonator from a liquid container. In some embodiments, the elevated pressures required to maintain water in a carbonated state after the carbonation process is above a threshold number, such as 30 psi. However, when the bottle is pressurized to that threshold number, the upward pressure on the carbonation device in a lid form factor increases the friction of the threads and therefore makes it difficult to remove by a user. It therefore advantageous to have a pressure release button which allows the user to further depressurize the system to atmospheric pressure to make the lid/carbonator/product easy to remove.

In some embodiments, a carbonation device includes a container cap for mounting to an opening of a liquid container. The carbonation device includes a cartridge retainer in the container cap for locating a carbonating fluid cartridge relative to the liquid container and a conduit extending from the cartridge retainer to an interior of the liquid container.

The conduit includes a first conduit section defining a segment of the conduit and being a channel having a cross-section with a first area and a second conduit section extending from the first conduit section to the interior of the liquid container. The second conduit section is a channel having a cross-section with a second area smaller than the first area. A carbonating fluid released from a carbonating fluid cartridge retained in the cartridge retainer first passes through the first conduit section and then passes through the second conduit section prior to entering the interior of the liquid container.

In some embodiments, the conduit includes a third conduit section extending from the first conduit section towards the cartridge retainer. The third conduit section is a channel having a cross-section with a third area smaller than the first area. In some such embodiments, the third conduit section is integrated into a piercer for piercing a mouth of a cartridge retained in the cartridge retainer during use.

In some embodiments having a third conduit section, wherein the third area is smaller than the second area.

In some embodiments, the first conduit section includes a one-way valve for preventing a reversal of flow direction towards the cartridge retainer. In some such embodiments, the one-way valve redirects flow around a portion of the one-way valve, thereby defining a partially serpentine path. The partially serpentine path maximizes angles along the path so as to avoid subjecting a carbonating fluid to right angled turns.

In some such embodiments, the partially serpentine path includes a cylindrical section such that tubular flow encloses a portion of the one-way valve.

In some embodiments, the conduit defines a path from the cartridge retainer to the interior of the liquid container, and the carbonating fluid does not pass through an expansion chamber, such that the carbonating fluid is maintained in liquid form until entering the second conduit section or an end segment of the first conduit section.

In some embodiments, an outer housing of the first conduit section and the second conduit section is a heat sink that draws heat from fluid along the first conduit section and the second conduit section.

In some embodiments, the second conduit section is formed from a low surface energy material.

In some embodiments, the interior of the liquid container has a defined fill level, and the second conduit section stops short of the defined fill level, such that when the liquid container is filled with liquid, an outer surface does not contact the liquid. In some such embodiments, during injection of the carbonating fluid during use, the liquid level rises above the liquid fill level such that the outer surface is in contact with the liquid.

In some embodiments, the interior of the liquid container has a defined fill level, and the second conduit section extends below the defined fill level, such that when the liquid container is filled with liquid, the second conduit section is at least partially submerged in the liquid.

In some embodiments, the cartridge retainer includes a cradle for retaining a mouth of a carbonating fluid cartridge relative to the conduit. In some such embodiments, the cradle orients the carbonating fluid cartridge such that it faces towards the liquid container.

In some embodiments utilizing a cradle, the cartridge retainer includes a secondary container cap for retaining the carbonating fluid cartridge within the container cap in concert with the cradle, and removal of the secondary container cap provides access to the carbonating fluid cartridge. In some such embodiments, upon mounting the secondary container cap to the container cap, rotation of the secondary container cap generates translation of the carbonating fluid cartridge retained in the cartridge retainer towards a piercer, thereby resulting in a piercing of a mouth of the cartridge.

In some embodiments utilizing a secondary container cap, the secondary container cap contains a magnetic element for retaining the carbonating fluid cartridge during fixation of the secondary container cap to the container cap.

In some embodiments, the container cap contains internal threading for mating with external threading of the liquid container.

In some embodiments, the carbonation device includes a bottle insert for insertion into the liquid container, where the bottle insert includes a water fill level indicator suspended within an interior space of the liquid container. In some such embodiments, the bottle insert remains inserted into the liquid container when the container cap is removed.

In some embodiments, the second conduit section is a nozzle.

### BRIEF DESCRIPTION OF THE DRAWINGS

FIG. 1 is a perspective view of an embodiment of a carbonation device in accordance with this disclosure.

FIG. 2 is a section view of the carbonation device of FIG. 1.

FIG. 3 is a partial section view of the carbonation device of FIG. 1

FIG. 4 is a perspective view of a nozzle housing of the carbonation device of FIG. 1.

FIG. 5 is a section view of the nozzle of FIG. 4 containing a conduit.

FIG. 6 is a section view of an alternate embodiment of a carbonation device in accordance with this disclosure applied to a liquid container.

FIG. 7 is a section view of an alternate embodiment of a carbonation device in accordance with this disclosure.

FIG. 8 is a section view of an alternate embodiment of a carbonation device in accordance with this disclosure.

FIG. 9 is a partial section view of an alternate embodiment of a carbonation device in accordance with this disclosure.

FIG. 10 is a partial section view of an alternate embodiment of a carbonation device in accordance with this disclosure.

FIG. 11 is a section view of an alternate embodiment of a carbonation device in accordance with this disclosure applied to a liquid container.

FIGS. 12A-G illustrate section views of several embodiments of a one-way valve for use in a carbonation device in accordance with this disclosure.

FIG. 13 is a partially exploded section view of an alternate embodiment of a carbonation device in accordance with this disclosure.

FIG. 14 shows only designated portions of an embodiment of the carbonation device applied to a container following a carbonation process.

FIG. 15 shows an embodiment of a carbonation device in accordance with this disclosure with certain components removed.

FIG. 16 is a section view of an embodiment of a carbonation device in accordance with this disclosure.

FIG. 17 is a section view of a valve for use in embodiments of a carbonation device in accordance with this disclosure.

FIG. 18 illustrates a carbonation process executable by embodiments of a carbonation device in accordance with this disclosure.

FIG. 19 illustrates a liquid container insert for use with a carbonation device in accordance with this disclosure.

FIG. 20 is a section view of an alternative implementation of the nozzle of FIG. 4.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

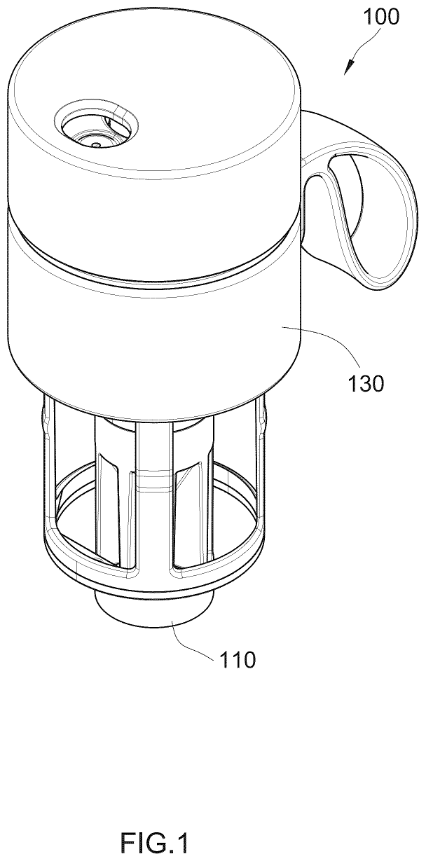

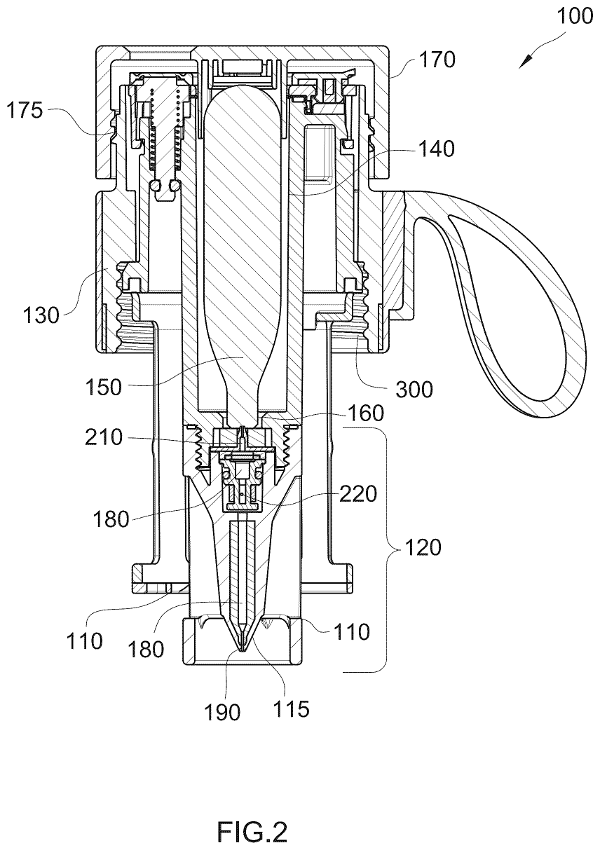

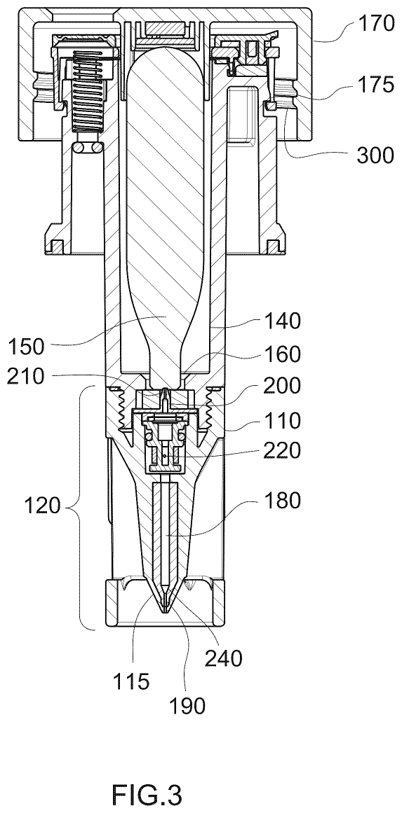

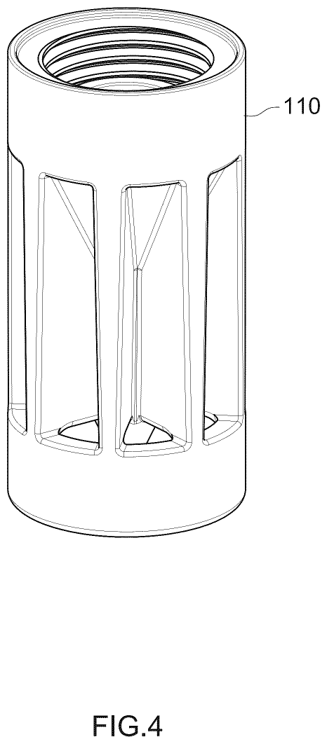

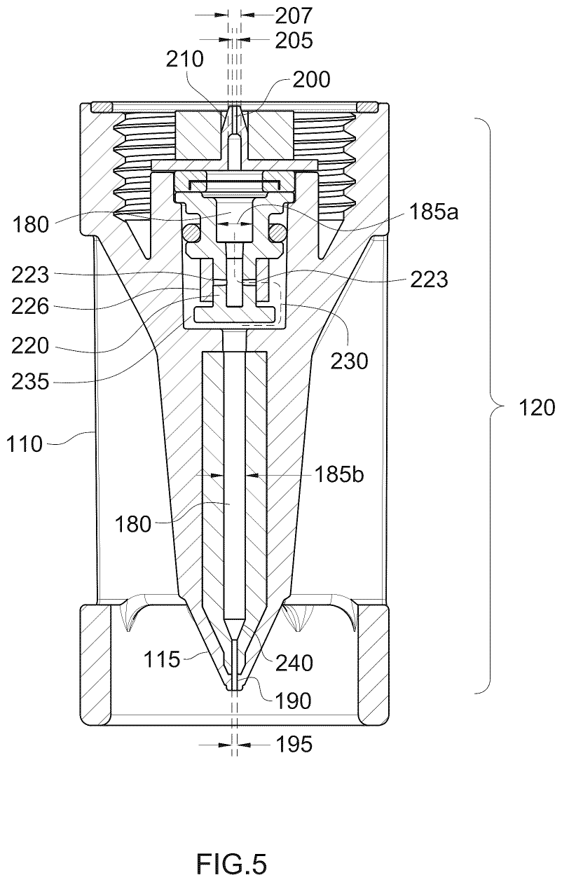

FIG. 1 is a perspective view of an embodiment of a carbonation device 100 in accordance with this disclosure. FIG. 2 is a section view of the carbonation device 100 of FIG. 1. FIG. 3 is a partial section view of the carbonation device 100 of FIG. 1. FIG. 4 is a perspective view of a nozzle housing 110 of the carbonation device 100 of FIG. 1. FIG. 5 is a section view of the nozzle housing 110 of FIG. 4 containing a conduit 120.

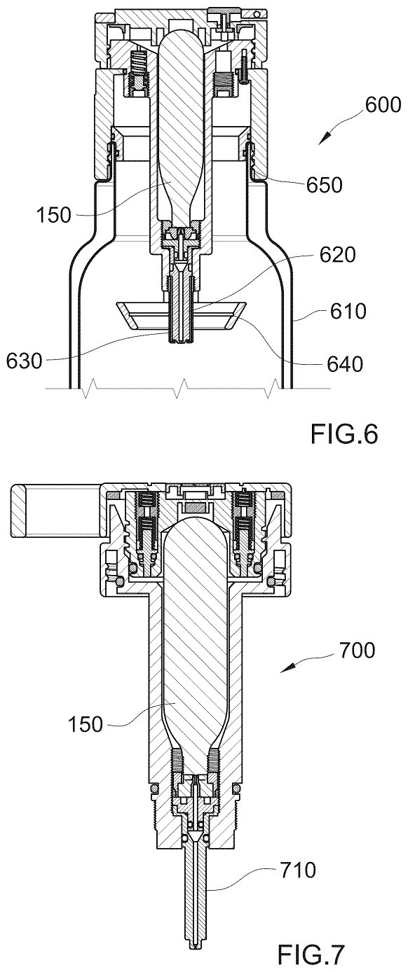

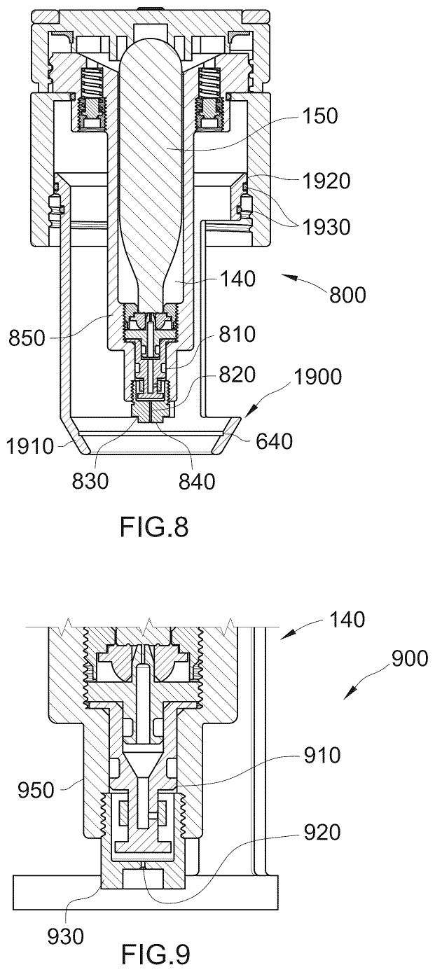

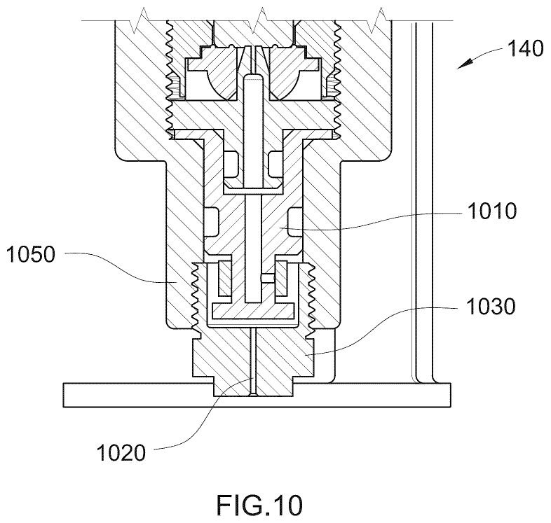

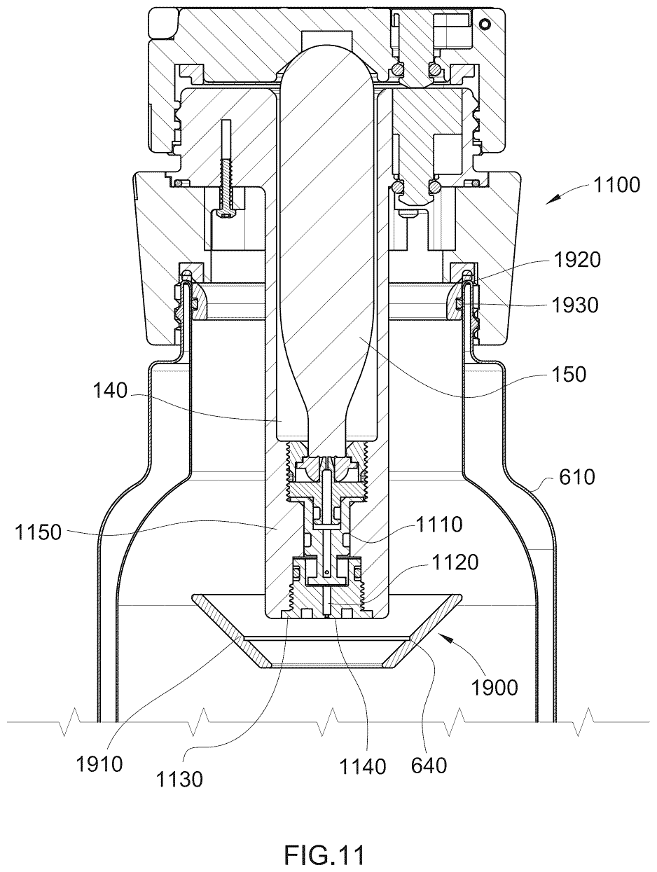

FIG. 6 is a section view of an alternate embodiment of a carbonation device 600 in accordance with this disclosure applied to a liquid container 610. FIG. 7 is a section view of an alternate embodiment of a carbonation device 700 in accordance with this disclosure. FIG. 8 is a section view of an alternate embodiment of a carbonation device 800 in accordance with this disclosure. FIG. 9 is a partial section view of an alternate embodiment of a carbonation device 900 in accordance with this disclosure. FIG. 10 is a partial section view of an alternate embodiment of a carbonation device 1000 in accordance with this disclosure. FIG. 11 is a section view of an alternate embodiment of a carbonation device 1100 in accordance with this disclosure applied to a liquid container.

The carbonation device 100 will be discussed primarily in the context of the embodiment of FIGS. 1-5, while the additional alternate embodiments of such a device 600, 700, 800, 900, 1000, 1100 will be referenced where relevant to call out specific potential features of the device. Each embodiment comprises many of the same elements, and in various embodiments, like elements will be referenced using like reference numerals.

As shown, a carbonation device 100 is provided that includes a container cap 130 for mounting to an opening of a liquid container (such as 610). A cartridge retainer 140 in the container cap 130 is provided for locating a carbonating fluid cartridge 150, such as a CO2 cartridge, relative to the liquid container 610. The cartridge retainer 140 may comprise, for example, a cradle 160 or other retainer form for receiving a mouth of a cartridge 150 retained therein. Such a cradle 160 may be paired with a secondary container cap 170, as discussed in more detail below in order to retain the cartridge 150 at both ends.

The carbonation device 100 further comprises a conduit 120 extending from the cartridge retainer 140 to an interior of the liquid container 610. The conduit 120 typically comprises multiple conduit segments which may have varying cross-sectional areas or diameters which then impact the behavior of the carbonating fluid passing through the conduit. For example, it may be desirable for a carbonating fluid to be maintained as a liquid until late in the passage through the conduit 120, with a transition to gas close to a final segment prior to entering the liquid container, such as at a nozzle 115. The conduit geometry may then impact when the carbonating fluid transitions between phases.

The conduit 120 may therefore comprise a first conduit section 180 defining a segment of the conduit and being a channel having a cross-section with a first area, such as a cylindrical channel with a first diameter 185a. It is noted that the first conduit section 180 may extend across multiple components and its diameter may change across such multiple components, such that in addition to the first diameter may be 185a, additional diameters 185b may exist along the conduit section 180 as discussed in more detail below.

The conduit 120 may then comprise a second conduit section 190 extending from the first conduit 180 section to the interior of the liquid container 610, the second conduit section 190 being a channel having a cross-section with a second area, or a second diameter 195, smaller than the first area or first diameter 185a. The second conduit 190 is typically a portion of the nozzle 115.

Accordingly, a carbonating fluid released from a carbonating fluid cartridge 150 retained in the cartridge retainer 140 first passes through the first conduit section 180 and then passes through the second conduit section 190 prior to entering the interior of the liquid container 610. In some embodiments, the second conduit section 190 functions as the nozzle 115 for depositing the carbonating fluid into the liquid container. When the carbonating fluid exits the conduit 120 at the nozzle 115, it is typically in gas form, having made the transition somewhere along the conduit 120. Accordingly, the second diameter 195 may be selected so as to generate an idealized bubble size for gas injected into a liquid in the liquid container 610.

In some embodiments, the conduit further comprises a third conduit section 200 extending from the first conduit section 180 towards the cartridge retainer 140. The third conduit section 200 may be a channel having a cross-section with a third area or third diameter 205 smaller than the first area or first diameter 185a, b. In this manner, the conduit may then have a third conduit section 200 adjacent the cartridge 150 providing a first small diameter 205, such as 0.4 mm in diameter, such that the rate at which liquid CO2 exits the cartridge can be controlled to an extent. The CO2 then enters the first conduit 180 section having a larger diameter 185a, b, but typically not a chamber or a diameter large enough to function as an expansion chamber, so as to avoid transitioning liquid CO2 to gas too early.

Accordingly, the conduit 120 defines a path from the cartridge retainer 140 to the interior of the liquid container 610 such that the carbonating fluid does not pass through an expansion chamber. Accordingly, the carbonating fluid is maintained in liquid form until entering the second conduit section 190 or an end segment of the first conduit section 180. As noted above, various portions of the first conduit section 180 may have distinct diameters 185a, b. Such diameters are selected so as to control flow expansion. Transitions between such diameters 185a, b may be gradual so as to avoid step discontinuities, as such discontinuities could lead to rapid expansions. Accordingly, tapered transitions between diameters 185a, b, 195 may be used, or multiple diameters may be used to gradually adjust the diameter of the conduit section 180.

Finally, just before exiting the conduit 120, the CO2 enters the second conduit section 190 having a smaller diameter 195 than the first conduit section 180. Such a conduit section 190 may have a diameter 195 of, for example, 0.6 mm. As such, in some embodiments, the third area or diameter 205, is smaller than the second area or diameter 195.

In some embodiments, the third conduit section 200 may be integrated into a piercer 210 for piercing a mouth of the cartridge 150 retained in the cartridge retainer 140 during use. In other embodiments, the conduit 120 may begin immediately following such a piercer 210.

In some embodiments, the third diameter 205 associated with the third conduit section 200 is constrained by the need to have a narrow piercing cone 210. Accordingly, the third diameter 205 may expand gradually, or the third conduit section 200 may have a second distinct diameter 207. As noted above, transitions between different diameters 205, 207, 185a, b, 195 are generally gradual so as to avoid step discontinuities resulting in rapid expansions. Accordingly, the second distinct diameter 207 of the third conduit section 200 may be provided as a transitional diameter between the third conduit section 200 and the first conduit section 180.

In some embodiments, the first conduit section 180 is interrupted by or further comprises a one-way valve 220 for preventing a reversal of flow direction towards the cartridge retainer 140. In such an embodiment, the one-way valve 220 may redirect flow around a portion of the one-way valve 220, thereby defining a partially serpentine path 230. In the embodiment shown, the one-way valve 220 may function by providing at least one orifice 223 through which the carbonating fluid can flow, with the orifice being enclosed or occluded by a barrier, such as a sleeve 226. In the embodiment shown, two such orifices 223 are provided. With sufficient pressure in the first conduit section 180, the carbonating fluid can displace the barrier 226 and thereby proceed through the orifice 223 along the serpentine path 230. However, if flow is reversed, the barrier 226 would occlude the orifice 223, thereby preventing carbonating fluid from returning to the cartridge 150. It is noted that the number and form the orifices 223 take may determine a flow rate for the one-way valve 220. Accordingly, if a higher flow rate is desired, the number of orifices 223 may be increased to, e.g., 5 or more, and if a lower flow rate is desired, a single orifice may be provided. Further, the orifices 223 may be changed in size or shape in order to facilitate a desired flowrate or characteristic.

Typically, the one-way valve 220 interrupts the first conduit section 180, and following the serpentine path 230, the carbonating fluid returns to a continuation of the first conduit section 180 or a transitional conduit 240 for a transition to the second conduit section 190. In other embodiments, the one-way valve 220 may be provided at an end of the first conduit section 180, such that the valve itself is provided at a transition from the first conduit section 180 to the second conduit section 190. Accordingly, the partially serpentine path 230 may direct the carbonating fluid from the end of the first conduit section 180, through the one-way valve, and to the beginning of the second conduit section 190.

It is noted that the partially serpentine path 230 defined may not be a linear path, as portions of the one-way valve and the corresponding housing may be rotationally symmetric or may otherwise define a cylindrical passage. Accordingly, following passage through the at least one orifice 223 and past the barrier 226, the fluid may enter a cylindrical chamber 235. Accordingly, the flow of the carbonating fluid is typically linear within the first conduit section 180, then passes through the at least one orifice 223, traveling in a radial direction, then transitions to an annular tubular flow within the cylindrical chamber 235, with a central void occupied by the one-way valve 220 in which there is no flow and constrained by the one-way valve body.

Following the tubular flow within the cylindrical chamber 235, the carbonating fluid flow is ducted back radially inward where it recombines to form a substantially linear flow in the continuation of the first conduit section 180. Accordingly, while the flow transitions from linear flow, to tubular flow, and back to linear flow, a linear approximation of such a flow is the partially serpentine path 230 shown. It is therefore understood that when referencing a serpentine path, such a description includes both a linear path followed by some of the carbonating fluid as well as a more complex transition between different path geometries defined by the one-way valve 220 and corresponding housing. Further, even if a portion of the flow is linear, such as the partially serpentine path 230 shown, the corresponding flow is typically not linear from a perspective of compression and expansion or a corresponding volumetric flow rate.

Further, as shown, the flow around the body of the one-way valve 220 or any other obstruction attempts to control flow rate and pressure by maintaining a low cross-sectional area orthogonal to the flow direction, which changes in a few places as shown by the hypothetical partially serpentine path 230. As noted, the flow splits around the one-way valve 220 and rejoins itself from all radial directions. Accordingly, to the extent that the linear partially serpentine path 230 shown is followed by carbonating fluid within the fluid conduit 120, such flow is typically mirrored for all orifices 223 when multiple orifices are provided. Further, the volume of the cylindrical chamber 235 may quickly be filled with carbonating fluid after the fluid passes the barrier 236, and all such fluid may then run together, creating a symmetrical tubular flow around the body of the one-way valve 220 before continuing down the first conduit section 180.

Many different geometries for such one-way valves 220 are contemplated and are shown in the various embodiments provided in the figures, including those shown in FIGS. 8-11 810, 910, 1010, 1110.

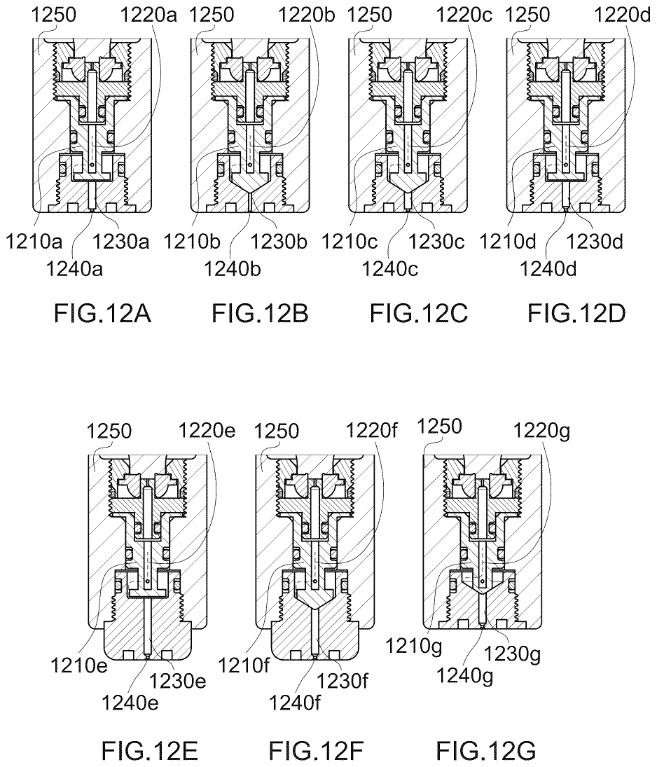

FIGS. 12A-G illustrate section views of several additional embodiments of one-way valves 1210a-g for use in a carbonation device in accordance with this disclosure. Each example shows a one-way valve 1210a-g either interrupting or termination a corresponding first conduit section 1230a-g. Fluid flow than continues to a second conduit section 1240a-g at a nozzle.

As shown, the partially serpentine paths 1220a-g in each embodiment may be modified so as to maximize angles along the path and avoid subjecting a carbonating fluid to right angled turns. For example, the final embodiment shown in FIG. 12G provides a one-way valve 1210g is integrated into a first conduit section 1230g and allows for a mostly straight path to the continuation of the first conduit section 1230g. Following an encounter with the one-way valve 1210g, the carbonating fluid is gently returned to the path. Such an approach may be effective in retaining the carbonating fluid, such as CO2, in liquid form for longer than otherwise possible, while providing the one-way valve 220, 1210a-g early in the conduit 120, such that most of the carbonating fluid in the conduit 120 is blocked from returning to the cartridge 150.

The various conduit sections 180, 190, 200 each may be provided with a corresponding housing section. For example, a nozzle housing 110 may be provided containing the nozzle, and such a housing may contain the entirety of or most of the conduit 120. As shown, in typical embodiments, an outer nozzle housing 110 of the first conduit section 180 and the second conduit section 190 can be thickened to function as a heat sink, in order to control a temperature change of fluid within the conduit 120. Indeed, the entire conduit 120 may be enclosed by the nozzle housing 110, which may be made large enough to function as a heat sink. Further, the nozzle housing 110 may be formed utilizing materials having high thermal conductivity or other material characteristics so as to so as to draw heat from the contained liquid along the conduit 120 and avoid drawing heat from the contained liquid only at the second conduit section 190.

Upon depositing the carbonating fluid into the liquid in the liquid container 610, the colder temperature of the carbonating fluid interacts with the liquid in the liquid container 610. If the temperature of the carbonating fluid at the nozzle 115 and in the third conduit section 190 is too low, then the resulting cooling of the liquid in the liquid container 610 is too rapid and too localized, thereby forming ice. The use of the nozzle housing 110 and other parts of the assembly as a larger heat sink avoids pulling heat from just the nozzle 115, thereby preventing ice formation.

Following the use of the nozzle housing 110 as a heat sink, a temperature differential remains between the carbonating fluid in the second conduit section 190 and the liquid in the liquid container 610. The relatively warm liquid in the liquid container interacts with the carbonating fluid in order to facilitate the conversion of liquid carbonating fluid, such as CO2, into gaseous carbonating fluid. This also warms the liquid CO2 and further assists in avoiding ice formation. Additionally, the liquid in the liquid container 610 is cooled slightly by the interaction, which increases carbonation performance.

It is further noted that portions of the fluid path followed by the carbonating fluid may be insulated. In particular, such insulation may be provided prior to the one-way valve 220 in order to avoid a phase change there, which could create a blockage. However, following the one-way valve 220, the nozzle housing 110 is typically configured to draw heat away from the fluid conduit 120.

Where the nozzle housing 110 is not provided as a discrete element containing most or all of the conduit 110, as in the embodiments of FIGS. 1-5, other configurations may be utilized to provide a heat sink for the nozzle and other components, thereby controlling temperature changes. Accordingly, in the embodiments of FIGS. 8-12g, an outer housing 850, 950, 1050, 1150, 1250 of the cartridge retainer 140 may be provided.

In addition to providing an outer housing to retain and partially control temperature changes within components, heat sink effectiveness may be enhanced by providing an appropriate material or by thickening a wall of the conduit 120, or portions of the conduit, itself. Accordingly, while some embodiments may utilize a straw-like structure 620, 710 to inject the carbonating fluid into a liquid container 610, some of those embodiments may provide an outer material 630 so as to draw heat away from a terminal end of the straw. Further, in many embodiments, instead of providing a straw 620, 710, portions of the conduit 120 may be embedded in a larger block of material, as shown in FIGS. 8-12G. In this way, the second conduit section 820, 920, 1020, 1120 may function as a nozzle, but would take the form of an orifice passing through the corresponding larger block of material 830, 930, 1030, 1130. Similarly, the nozzle housing 110 may function as such a larger block of material containing the segments of the conduit 120, and the one-way valve 810, 910, 1010, 1110, 1210a-g may be provided with more bulk than would be structurally necessary so as to enhance its capacity to draw temperature from a nozzle.

Additional features may be provided to minimize ice formation as well. In some embodiments, the second conduit section 190, 820, 920, 1020, 1120, or the block of material 830, 930, 1030, 1130 in which the second conduit section is provided, may comprise a low surface energy material. This may prevent water adjacent to the second conduit section 190, 820, 920, 1020, 1120 from forming ice and attaching to the block of material 830, 930, 1030, 1130.

Further, the outer surface of the second conduit section 190, 830, 930, 1030, 1130 facing the interior of the liquid container 610, such as the outer or downward facing surface of the block of material 830, 930, 1030, 1130, may be otherwise optimized to minimize ice formation and adherence. In addition to selecting for a low surface energy material, the material may be polished or shaved to avoid roughness on which ice can form. Other material properties may prevent ice formation as well.

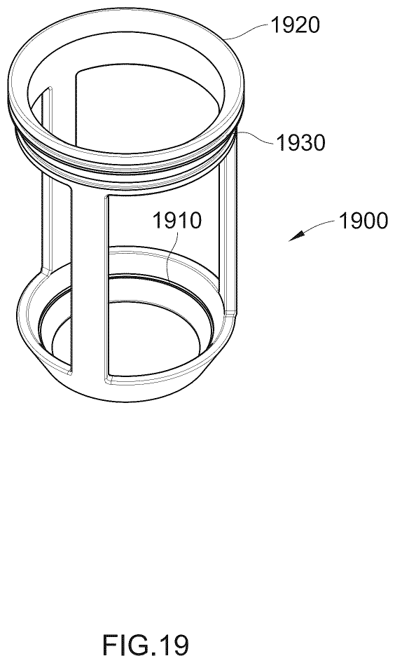

In some embodiments, the interior of the liquid container has a defined fill level 640. The second conduit section 190, 830, 930, 1030, 1130 may then be positioned relative to the defined fill level 640 so that the injection of the carbonating fluid can be controlled in view of the configuration and location of the corresponding nozzle. Accordingly, in some embodiments, such as that shown in FIG. 8, the second conduit section 820 may be positioned so as to stop short of the defined fill level 640. In such a configuration, when the liquid container 610 is filled with liquid, an outer and downward facing surface 840, 1140 of the second conduit section 820, 1120 does not contact the liquid in the liquid container. A similar approach is shown with respect to the carbonation device 1100 shown in FIG. 11. The carbonation device may include a component 1900 for defining such a fill level 640, such as that shown in FIG. 19 and discussed in more detail below.

In embodiments where the defined fill level 640 is below the reach of the second conduit section 820, 1120, the fill level 640 may be defined such that once an injection of the carbonating fluid begins during use, the liquid level rises above the liquid fill level 640 such that the outer surface 840, 1140 of the second conduit section 820, 1120 comes in contact with the liquid.

In other embodiments, when the interior of the liquid container 610 has a defined fill level 640, the second conduit section 190 is configured to extend below the defined fill level. Accordingly, when the liquid container is filled with liquid, the second conduit section 190 may be at least partially submerged in the liquid. Accordingly, carbonating fluid injected into the liquid by way of the second conduit section 190 is injected below the surface of the liquid.

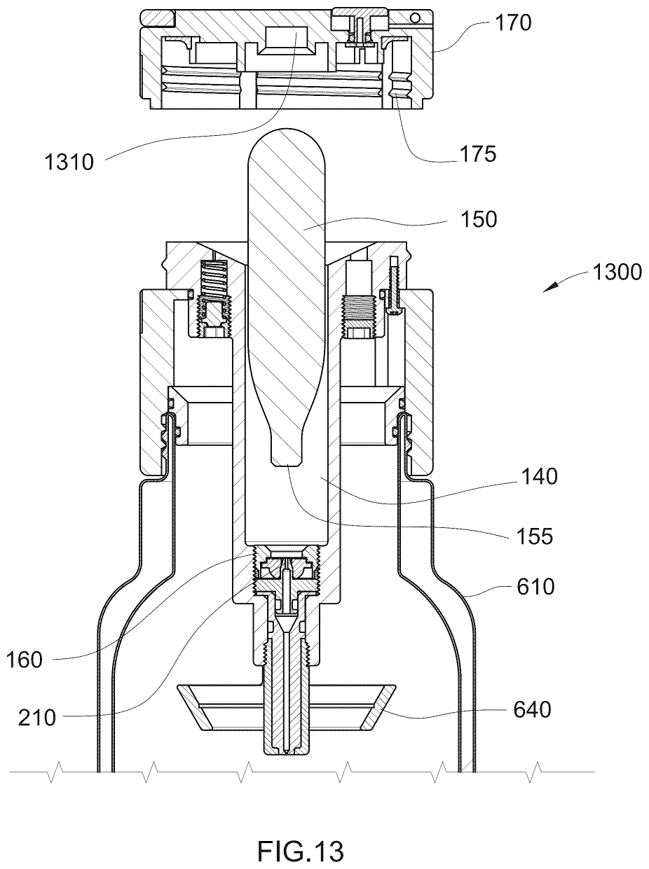

FIG. 13 is a partially exploded section view of an embodiment of a carbonation device 1300 in accordance with this disclosure.

As noted above, in some embodiments, the cartridge retainer 40 comprises a cradle 160 for retaining a mouth 155 of a carbonating fluid cartridge 150 relative to the conduit 120. In some such embodiments, the cradle 160 orients the carbonating fluid cartridge 150 such that it faces towards the liquid container 610. In other words, the cartridge 150 may be mounted such that the mouth 155 faces downwards.

In some embodiments, the cartridge retainer 140 further comprises a secondary container cap 170 for retaining the carbonating fluid cartridge 150 within the container cap 130 in concert with the cradle 160. Removal of the secondary container cap 170 may then provide access to the carbonating fluid cartridge 150. In such an embodiment, upon mounting the secondary container cap 170 to the container cap 130, rotation of the secondary container cap 170 may generate translation of the carbonating fluid cartridge 150 retained in the cartridge retainer 140 towards a piercer 210. This would then result in a piercing of a mouth 155 of the cartridge 150, which may in turn initiate a carbonation process.

In some such embodiments, the container cap 130 and the secondary container cap 170 may be threaded 175 for mating, such that rotating the secondary container cap 170 on the threading 175 forces translation of the cartridge 150 towards the piercer 210. In some embodiments, a portion 1310 of the retainer 140 integrated into the secondary container cap 170 may be magnetic or may otherwise retain the cartridge 150 prior to insertion into the cradle 160, so as to ease the handling of the cartridge 150 during fixation of the secondary container cap 170 to the container cap 130.

In some embodiments, the container cap 130 contains internal threading 300 for mating with external threading 650 of the liquid container 610. Such internal threading 300 may be provided with features for enhanced grip across various thread sizes and geometries.

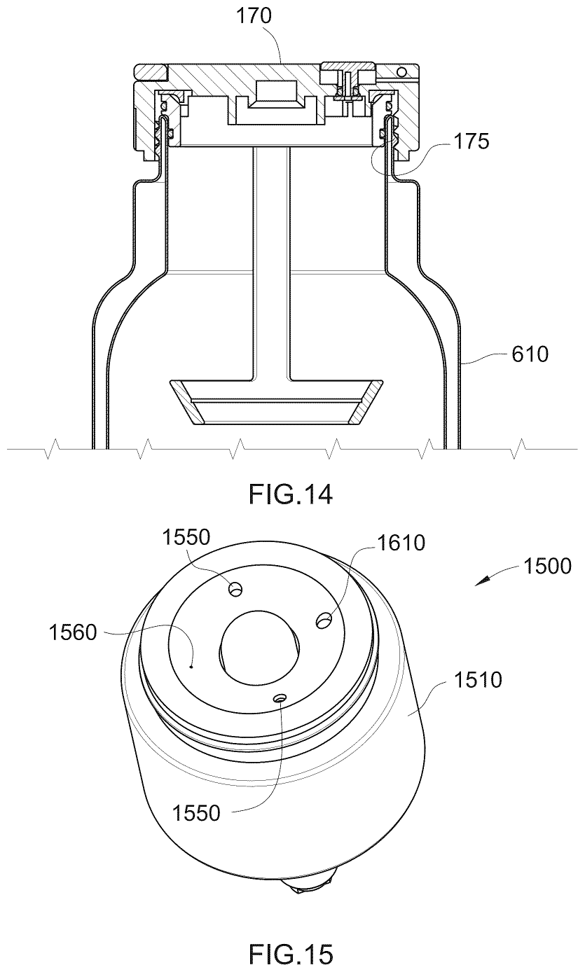

FIG. 14 shows only designated portions of the carbonation device 100 applied to a container 610 following a carbonation process.

In some embodiments, the threading 175 of the secondary container cap 170 may be similar to or identical to the internal threading 300 of the container cap 130, such that following a carbonating process, the container cap 130 may be removed, and the secondary container cap 170 can mate directly with the liquid container 610, as shown in FIG. 13.

In some embodiments, the carbonation device 100 further comprises a bottle insert 1900 for insertion into the liquid container. Such an insert 1900 is shown, for example, in FIG. 19 and various implementations of such an insert 1900 are visible in FIGS. 1, 2, 6, 8-11, 13, 14, and 16. Such an insert 1900 may include a water fill level indicator 1910, shown as a linear indicator, which may be suspended within an interior space of the liquid container 610. Because different bottles may have different internal geometries, such an insert 1900 may allow the carbonation device to achieve more consistent results.

In some embodiments, the insert 1900 is inserted into the liquid container 610 prior to insertion of the rest of the carbonation device 100, and it may remain in the liquid container 610 when the carbonation device 100 is removed. In order to facilitate such an insertion, a neck 1920 of the insert may be sized for close fit or a slight interference fit with the liquid container 610 so that once inserted, such insertion is semi-permanent. Where a clearance fit is used, one or more seals 1930, such as O-rings, may be fitted into the neck 1920 in order to create a liquid seal. Accordingly, as shown in FIG. 14, the insert 1900 may remain in place following carbonation.

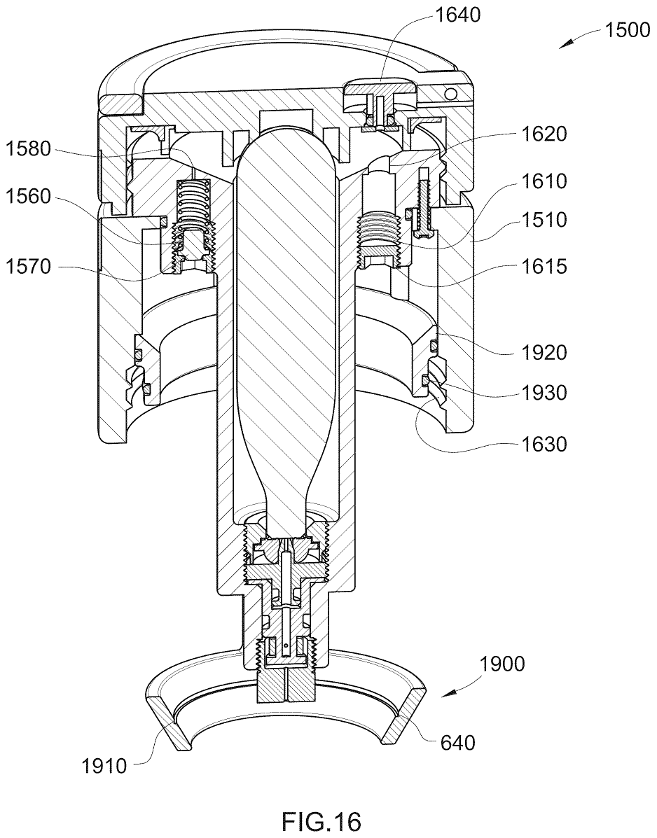

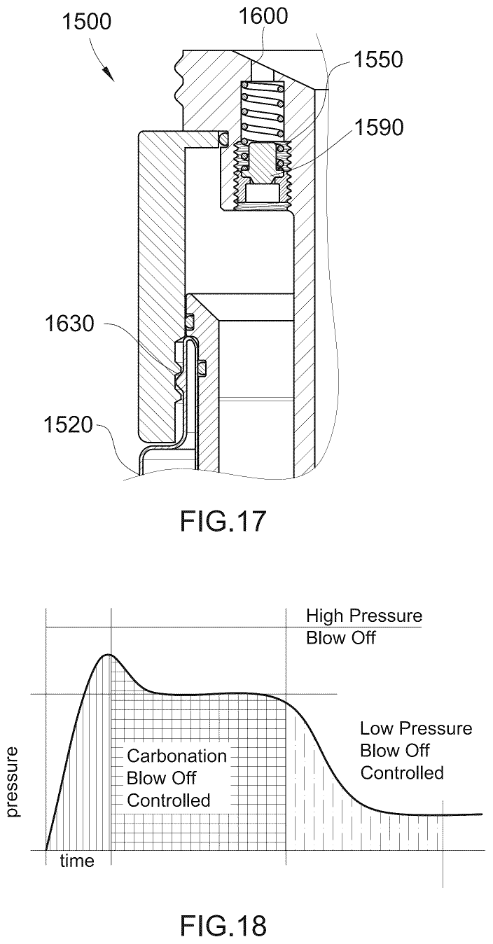

FIG. 15 shows an embodiment of a carbonation device 1500 in accordance with this disclosure with certain components removed. FIG. 16 is a section view of an embodiment of a carbonation device 1500 in accordance with this disclosure. FIG. 17 is a section view of a valve 1600 for use in embodiments of a carbonation device 1500 in accordance with this disclosure.

As shown, a carbonation device 1500 may comprise a container cap 1510 for mounting to an opening of a liquid container 1520 and a cartridge retainer 1530 in the container cap 1510 for locating a carbonating fluid cartridge 1540 relative to the liquid container 1520.

Various blow-off valves are described in the context of the carbonation device 1500. Each such blow-off valve is a pressure release valve that has a defined relief pressure, or a pressure at which the valve opens, and a defined relief flow rate. Accordingly, if a pressure in the liquid container 1520 exceeds the blow-off pressure of a particular blow-off valve, the corresponding valve opens and allows fluid to flow through the valve at the relief flow rate.

The carbonation device 1500 is typically provided with at least one carbonation pressure blow-off valve 1550 in the container cap 1510 for limiting pressure during a carbonation process. The carbonation pressure blow-off valve 1550 may be set to a relief pressure above a projected or desired carbonation pressure. Such a carbonation pressure blow-off valve 1550 may then set a pressure at which carbonation occurs during normal operation. Accordingly, if carbonation is occurring within the liquid container 1520 at the projected or desired carbonation pressure, the carbonation pressure blow-off valve 1550 will remain closed. If carbonation is occurring within the liquid container at a pressure well above the projected or desired carbonation pressure, the carbonation pressure blow-off valve 1550 will open and allow fluid to flow at its relief flow rate until pressure is reduced to the relief pressure.

The carbonation device 1500 also has at least one low pressure blow-off valve 1560 independent of the carbonation pressure blow-off valve 1550. The low-pressure blow-off valve 1560 has a relief pressure below the carbonation pressure blow-off valve 1550 relief pressure.

The low-pressure blow-off valve 1560, when open, defines a relief flow rate lower than the relief flow rate defined by the carbonation pressure blow-off valve 1550, and the low-pressure blow-off valve 1560 may then remain open during a carbonation process.

Accordingly, as discussed below with respect to FIG. 18, a carbonation process may have a high pressure, or a primary carbonation pressure, corresponding to a projected or desired carbonation pressure, as well as a lower pressure, or a final carbonation pressure, corresponding to a pressure that the carbonation device 1500 settles at following a carbonation process. The carbonation pressure blow-off valve 1550 may define the primary carbonation pressure by its relief pressure, while the low-pressure blow-off valve 1560 may define the final carbonation pressure by its relief pressure.

Accordingly, the low-pressure blow-off valve 1560 is typically open during the carbonation process, since its own relief pressure is below the primary carbonation pressure. However, the flow rate is typically so low that it does not meaningfully impact the carbonation process other than guiding the carbonation pressure towards the final carbonation pressure over time. As such, the valve provides a slow release, or a leak, down to a set pressure.

Accordingly, while the relief pressure for the carbonation pressure blow-off valve 1550 may be relatively high, such as 90 PSI, the relief pressure of the low-pressure blow-off valve 1560 may then be a 5-40 PSI lower, or in some embodiments, 5-15 PSI lower, in order to allow the carbonation process to gradually settle at, e.g., 80 PSI, while continuing to maintain a high pressure. Such a relief pressure may be higher than a desired storage pressure for carbonated liquid. Accordingly, the carbonation process may settle at, e.g., 80 PSI, and the storage pressure may be, e.g., 60 PSI.

Alternatively, the relief pressure of the low-pressure blow-off valve 1560 may be a desired storage pressure for carbonated liquid, such as 60 psi. In this way, the liquid container 1520 with a cap 1510 in place can be maintained at a safe pressure above ambient pressure in order to maintain carbonation of a previously carbonated beverage. However, if pressure rises too high, it will slowly release over time to maintain safety.

This is visible in FIG. 15, which shows the low-pressure blow-off valve 1560 on the left with a very small orifice defining a very low flow rate. The at least one carbonation pressure blow-off valve 1550 is two valves, at the top and bottom of the drawing.

The second view of FIG. 16 shows a section view of the low-pressure blow-off valve 1560, with the internal valve core 1570, which can be tuned to a desired pressure, combined with a very small orifice 1580. The section view of FIG. 17 shows the carbonation pressure blow-off valve 1550, which combines a similar internal valve 1590, tuned differently, with a larger orifice 1600.

In some embodiments, the carbonation device also includes a high-pressure blow-off valve 1610, the high-pressure blow-off valve set to a relief pressure above the relief pressure of the carbonation pressure blow-off valve. The high-pressure blow-off valve 1610 defines a relief flow rate higher than the relief flow rate defined by the carbonation pressure blow-off valve. This can be seen as a larger opening size on the right of FIG. 15 and on the right side of the section view of FIG. 16.

Because the carbonating fluid cartridge is directly depositing the carbonating fluid into the liquid container by way of the container cap 1510 described above, in some cases, a component failure or other unexpected event may result in a pressure well above the desired carbonation pressure, resulting in unsafe conditions. In such a scenario, the high-pressure blow-off valve 1610 may be provided as an emergency release to very quickly release built up pressure.

In some embodiments, this type of dangerous pressure may occur when the carbonation device is operated upside down. In such an embodiment, liquid in the liquid container may be forced against the container cap 1510 while gas pressure builds up. Accordingly, the high-pressure blow-off valve 1610 may be configured to allow liquid flow. Typically, where such a high-pressure blow-off valve 1610 is implemented, a valve core 1615 is included, similar to the other valves described 1550, 1560, but tuned to a higher pressure. When open, such a valve 1610 defines a relief passage 1620 having a larger area than a relief passage, or orifice 1600 defined by the carbonation pressure blow-off valve 1550, thereby allowing for a quicker evacuation of pressure.

In some embodiments, the carbonation pressure blow-off valve (or valves) 1550 and the low-pressure blow-off valve 1560 may be configured to prevent the flow of liquid, so that even if all valves are open due to extreme pressure, all liquid is directed through the larger area or diameter high-pressure blow-off valve. Accordingly, during normal operating conditions and at normal operating pressures, none of the valves would allow liquid to escape.

In some embodiments, different combinations of valves 1550, 1560, 1610 may be provided. As such, the high-pressure blow-off valve 1610 may be provided without the low-pressure blow-off valve 1560. Similarly, the low-pressure blow-off valve 1560 may be provided without the high-pressure blow-off valve 1610.

In some embodiments, the at least one carbonation pressure blow-off 1550 valve may be two valves, as shown, set to substantially the same relief pressure. In some embodiments, the carbonation pressure blow-off 1550 valve may be omitted, and the carbonation process may be tuned so as to carbonate the liquid more efficiently and with less waste. Such tuning may be by way of controlling orifice sizes within the conduit 120, for example.

In some embodiments, a bleed button 1640 may be provided for allowing a user to manually open a valve or orifice in order to allow for the release of pressure to lower the pressure inside the liquid container 1520 to below the relief pressure of the low-pressure blow-off valve 1560. For example, as noted above, the low-pressure blow-off valve 1560 may provide a final carbonation pressure well above ambient pressure. Accordingly, if the carbonation process settles at, e.g., 80 PSI, the pressure may remain high enough to apply upward pressure the container cap 1510 and corresponding threading 1630 fixing the container cap 1510 to the liquid container 1520. This level of pressure may make it difficult, or dangerous, to remove the container cap 1510. By using such a bleed button 1640, the pressure may be reduced to a pressure low enough and close enough to atmospheric pressure that the container cap can be more easily removed.

Similarly, where the bottle is resealed and rises to a storage pressure, or where the low-pressure blow-off valve 1560 is configured to reduce pressure to a storage pressure, the liquid container 1520 may still be at a pressure sufficient to make it difficult or dangerous to remove the container cap 1510. Accordingly, the bleed button 1640 may further reduce pressure in order to ease the removal of the container cap 1510 from the liquid container 1520.

In some embodiments, as noted above, it may be dangerous to remove the container cap 1510 from the liquid container 1520 without first bleeding pressure. Accordingly, in some embodiments, an interlock may be provided in order to require the pressing of the bleed button 1640 in order to open the liquid container 1520.

FIG. 18 illustrates a carbonation process executable by embodiments of a carbonation device 1510 in accordance with this disclosure. As shown, during a normal carbonation process, the internal pressure may initially rise above the desired carbonation pressure, but may then be returned to the desired pressure by way of the carbonation pressure blow-off valve 1550. The carbonation process may then occur at the desired pressure, followed by a trail off in pressure to the low-pressure blow-off valve 1560 controlled pressure. As noted above, this trail off in pressure may be to a final carbonation pressure or to a storage pressure. During normal operation, the internal pressure never approaches the relief pressure for the high-pressure blow-off valve 1610.

As one example, the carbonation pressure may be set to a maximum of 90 psi by way of the carbonation pressure blow-off valve 1550, the low-pressure blow-off valve 1560 may constantly drive the pressure down to about 80 psi, while the high-pressure blow-off valve 1560 may be triggered if pressure rises above 110 psi.

In some cases, as noted above, the low-pressure blow-off valve 1560 may be set to a storage pressure, such as 60 PSI. In such a scenario, the low-pressure blow-off valve may not open until a pressure higher than its set pressure, such as 65 psi, so as to avoid a constant leak once the valve opens. Alternatively, a lower storage pressure, such as 30 PSI, may be utilized, in which case a the low-pressure blow-off valve 1560 may not open until a higher pressure, such as 35 PSI, is identified. Further, as noted above, the low-pressure blow-off valve 1560 may maintain a low pressure higher than the storage pressure, such as 80 PSI, such that the valve is actuated only if pressure increases significantly during storage.

In some embodiments, the high-pressure blow-off valve 1610 may be replaced with a one time use release feature, such as a burst disc or a rupture disc. As noted above, the high-pressure threshold should not be reached during normal carbonation processes, and as such the disc should typically not rupture, but if it did, it should be replaced.

FIG. 19 illustrates a liquid container insert 1900 for use with a carbonation device in accordance with this disclosure, previously discussed.

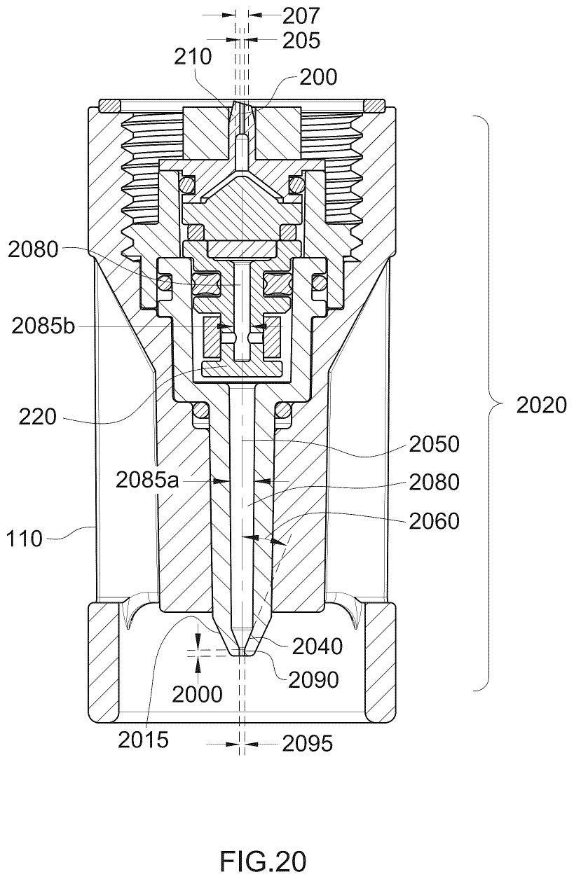

FIG. 20 is a section view of an alternative implementation of the nozzle 110 of FIG. 4. The changes in geometry shown in FIG. 20 are integrated into a nozzle housing similar or identical to that shown in FIG. 4, and the corresponding details are therefore not reiterated.

As discussed above, the carbonation device 100 comprises a conduit 2020 extending from the cartridge retainer 140 to an interior of the liquid container 610. The conduit 2020 typically comprises multiple conduit segments which may have varying cross-sectional areas or diameters which then impact the behavior of the carbonating fluid passing through the conduit. For example, it may be desirable for a carbonating fluid to be maintained as a liquid until late in the passage through the conduit 2020, with a transition to gas close to a final segment prior to entering the liquid container, such as at a nozzle 2015. The conduit geometry may then impact when the carbonating fluid transitions between phases.

The conduit 2020 may therefore comprise a first conduit section 2080 defining a segment of the conduit and being a channel having a cross-section with a first area, such as a cylindrical channel with a first diameter 2085a. It is noted that the first conduit section 2080 may extend across multiple components and its diameter may change across such multiple components, such that in addition to the first diameter may be 2085a, additional diameters 2085b may exist along the conduit section 2080 as discussed in more detail below.

The conduit 2020 may then comprise a second conduit section 2090 extending from the first conduit 2080 section to the interior of the liquid container 610, the second conduit section 2090 being a channel having a cross-section with a second area, or a second diameter 2095, smaller than the first area or first diameter 2085a. The second conduit 2090 is typically a portion of the nozzle 2015. As such, the second diameter 2095 is a nozzle diameter and the second conduit section 2090 is an outlet channel.

Accordingly, a carbonating fluid released from a carbonating fluid cartridge 150 retained in the cartridge retainer 140 first passes through the first conduit section 2080 and then passes through the second conduit section 2090 prior to entering the interior of the liquid container 610. In some embodiments, the second conduit section 2090 functions as the nozzle 2015 for depositing the carbonating fluid into the liquid container 610. When the carbonating fluid exits the conduit 2020 at the nozzle 2015, it is typically in gas form, having made the transition somewhere along the conduit 2020. Accordingly, the second diameter 2095, or nozzle diameter, may be selected so as to generate an idealized bubble size for gas injected into a liquid in the liquid container 610.

Further, the second conduit section 2090 may have a defined outlet channel length 2100 which may be limited so as to further control injection parameters. Accordingly, the nozzle diameter 2095 and the outlet channel length 2100 may be in a defined relationship, such that a ratio of the outlet channel length to the nozzle diameter is less than or equal to 1.2. For example, the second diameter, or nozzle diameter 2095, may be 0.5 mm, and the outlet channel length may be 0.6 mm.

In some embodiments, the conduit further comprises a third conduit section 200 extending from the first conduit section 2080 towards the cartridge retainer 140. The third conduit section 200 may be a channel having a cross-section with a third area or third diameter 205 smaller than the first area or first diameter 2085a, b. In this manner, the conduit may then have a third conduit section 200 adjacent the cartridge 150 providing a first small diameter 205, such as 0.4 mm in diameter, such that the rate at which liquid CO2 exits the cartridge can be controlled to an extent. The CO2 then enters the first conduit 2080 section having a larger diameter 2085a, b, but typically not a chamber or a diameter large enough to function as an expansion chamber, so as to avoid transitioning liquid CO2 to gas too early.

In some embodiments, the third conduit section 200 may be integrated into a piercer 210 for piercing a mouth of the cartridge 150 retained in the cartridge retainer 140 during use. In other embodiments, the conduit 120 may begin immediately following such a piercer 210.

In some embodiments, the third diameter 205 associated with the third conduit section 200 is constrained by the need to have a narrow piercing cone 210. Accordingly, the third diameter 205 may expand gradually, or the third conduit section 200 may have a second distinct diameter 207. As noted above, transitions between different diameters 205, 207, 2085a, b, 2095 are generally gradual so as to avoid step discontinuities resulting in rapid expansions. Accordingly, the second distinct diameter 207 of the third conduit section 200 may be provided as a transitional diameter between the third conduit section 200 and the first conduit section 2080.

Similarly, a transitional conduit section 2040 may be provided between the first conduit section 2080 and the second conduit section 2090. As each of the first and second conduit sections 2080, 2090 typically have circular cross sections, the transitional conduit section 2040 may take the form of a truncated conical surface defined about an axis 2050. In order to provide a smooth transition and to limit creation of ice at the transition between the first and second conduit sections 2080, 2090, an angle 2060 between the surface of the transitional conduit section 2040 and the axis 2050 is approximately 45 degrees. While the target value for this angle is 45 degrees, a range of +/−5 degrees would similarly limit creation of ice at the transition.

In some embodiments, the first conduit section 2080 is interrupted by or further comprises a one-way valve 220 for preventing a reversal of flow direction towards the cartridge retainer 140. Such a one-way valve 220 is discussed in more length above with respect to FIG. 5, and the corresponding details are not reiterated here.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A carbonation device comprising:
a container cap for mounting to an opening of a liquid container;
a cartridge retainer in the container cap for locating a carbonating fluid cartridge relative to the liquid container;
a conduit extending from the cartridge retainer to an interior of the liquid container, the conduit comprising:
a first conduit section defining a segment of the conduit and being a channel having a cross-section with a first area;
a second conduit section extending from the first conduit section to the interior of the liquid container, the second conduit section being a channel having a cross-section with a second area smaller than the first area, a nozzle diameter, and an outlet channel length, wherein a ratio of the outlet channel length to the nozzle diameter is less than or equal to 1.2, and
wherein a carbonating fluid released from a carbonating fluid cartridge retained in the cartridge retainer first passes through the first conduit section and then passes through the second conduit section prior to entering the interior of the liquid container.

2. The carbonation device of claim 1, wherein the conduit further comprises a third conduit section extending from the first conduit section towards the cartridge retainer, the third conduit section being a channel having a cross-section with a third area smaller than the first area.

3. The carbonation device of claim 2, wherein the third conduit section is integrated into a piercer for piercing a mouth of a cartridge retained in the cartridge retainer during use.

4. The carbonation device of claim 2, wherein the third area is smaller than the second area.

5. The carbonation device of claim 1, wherein the first conduit section comprises a one-way valve for preventing a reversal of flow direction towards the cartridge retainer.

6. The carbonation device of claim 5, wherein the one-way valve redirects flow around a portion of the one-way valve, thereby defining a partially serpentine path, wherein the partially serpentine path maximizes angles along the path so as to avoid subjecting a carbonating fluid to right angled turns.

7. The carbonation device of claim 6, wherein the partially serpentine path includes a cylindrical section such that tubular flow encloses a portion of the one-way valve.

8. The carbonation device of claim 1, wherein the conduit defines a path from the cartridge retainer to the interior of the liquid container, and wherein the carbonating fluid does not pass through an expansion chamber, such that the carbonating fluid is maintained in liquid form until entering the second conduit section or an end segment of the first conduit section.

9. The carbonation device of claim 1, wherein an outer housing of the first conduit section and the second conduit section is a heat sink that draws heat from fluid along the first conduit section and the second conduit section.

10. The carbonation device of claim 1, wherein the interior of the liquid container has a defined fill level, and wherein the second conduit section stops short of the defined fill level, such that when the liquid container is filled with liquid, an outer surface does not contact the liquid.

11. The carbonation device of claim 10, wherein during injection of the carbonating fluid during use, the liquid level rises above the liquid fill level such that the outer surface is in contact with the liquid.

12. The carbonation device of claim 1, wherein the interior of the liquid container has a defined fill level, and wherein the second conduit section extends below the defined fill level, such that when the liquid container is filled with liquid, the second conduit section is at least partially submerged in the liquid.

13. The carbonation device of claim 1, wherein the cartridge retainer comprises a cradle for retaining a mouth of a carbonating fluid cartridge relative to the conduit.

14. The carbonation device of claim 13, wherein the cartridge retainer further comprises a secondary container cap for retaining the carbonating fluid cartridge within the container cap in concert with the cradle, and wherein removal of the secondary container cap provides access to the carbonating fluid cartridge.

15. The carbonation device of claim 14, wherein upon mounting the secondary container cap to the container cap, rotation of the secondary container cap generates translation of the carbonating fluid cartridge retained in the cartridge retainer towards a piercer, thereby resulting in a piercing of a mouth of the cartridge.

16. The carbonation device of claim 14, wherein the secondary container cap contains a magnetic element for retaining the carbonating fluid cartridge during fixation of the secondary container cap to the container cap.

17. The carbonation device of claim 1 wherein the container cap contains internal threading for mating with external threading of the liquid container.

18. The carbonation device of claim 1, wherein the second conduit section is a nozzle.

19. The carbonation device of claim 1 further comprising a transitional conduit section extending from the first conduit section to the second conduit section having a substantially truncated conical surface providing a transition between the first area and the second area.

20. The carbonation device of claim 19, wherein the substantially truncated conical surface of the transitional conduit section defines an approximately 45 degree angle with an axis of the second conduit section.
